(19) United States
(12) Patent Application Publication
(10) Pub. No.: US 2011/0120020 A1
(43) Pub. Date: May 26, 2011

(54) DEVICE FOR CLOSING OFF A WINDOW MADE IN A MOTOR VEHICLE, CORRESPONDING ROOF AND CORRESPONDING VEHICLE

(75) Inventors: Pascal Fourel, Saint-Malo (FR); Xavier Sandrin, Bressuire (FR); David Billy, Bressuire (FR)

(73) Assignee: ADVANCED COMFORT SYSTEMS FRANCE SAS - ACS FRANCE, Bressuire Cedex (FR)

(21) Appl. No.: 12/992,975

(22) PCT Filed: May 18, 2009
(86) PCT No.: PCT/EP2009/056022

§ 371 Date: Feb. 3, 2011

(30) Foreign Application Priority Data
May 16, 2008 (FR) 0853210

(51) Int. Cl. B60J 7/057

(52) U.S. Cl. 49/358

(57) ABSTRACT

A device is provided for closing off a window made in a motor vehicle. The device includes a fixed part intended to be attached to the vehicle and at least one movable glazed panel able to move along a sliding axis between a closed position in which it closes off an opening defined in the fixed part and at least one open position in which the opening is at least partially free. The device includes at least one cable attached to the movable panel, a portion of the cable bearing the movable panel, moving parallel to the sliding axis in order to move the movable panel and engaging with a displacement device able to shift the movable panel from a closing plane corresponding to the plane of the fixed part to a sliding plane parallel to the closing plane.

### CROSS-REFERENCE TO RELATED APPLICATIONS

This Application is a Section 371 National Stage Application of International Application No. PCT/EP2009/056022, filed May 18, 2009 and published as WO 2009/138518 on Nov. 19, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of windows of motor vehicles.

More precisely, the disclosure relates to devices for closing off a window arranged in the body of a vehicle comprising a movable glass able to release or close an opening in the window.

In the framework of this application, the terms “window glass”, or “glazed panel” mean any substantially transparent or translucent panel (fixed or mobile) contributing to the window surface allowing light transmission, made of glass or of any suitable material, such as polyurethane. The edges of the panel can be opacified, for example via screen printing. In certain embodiments, the panel can be constituted of several flush elements, seen from the exterior, and, where applicable, at least one of these elements can be opaque, and for example made of metal.

A device according to the disclosure can be provided on a window of the roof of a vehicle or any other window formed in a substantially horizontal portion of the body of the vehicle. It can also be provided on a substantially vertical window of the vehicle.

### BACKGROUND OF THE DISCLOSURE

The current trend, in terms of motor vehicles, whether entailing an automobile, a utility vehicle, a lorry, or a coach, is to offer an increasing amount of glazed surfaces. As such, in particular, vehicles having a roof provided with one or several glazed elements have been proposed. In certain cases, the entire roof is made of glass or of a similar material that allows sunlight to pass through.

In such a way as to increase the window surface allowing light transmission, it has been sought on the other hand to propose glazed surfaces of large size while minimising the number of glazed panels of the roof. For example, the back window or the windscreen can be located in the extension of the glazed roof, in order to provide a visual appearance of continuity (without visible and protruding frame or separation strut, seen from the exterior, even if, in practice, they correspond to separate glazed elements).

It also had to be taken into account the fact that these glazed surfaces must be incorporated into the roofs of current or future vehicles that have streamlined shapes and are generally not flat and most often curved or rounded in the direction of the width and also, sometimes, in the direction of the length.

On the other hand, solutions have been proposed to create openings in the roof, in particular in order to be able to form a sunroof module.

As such, a common technique for releasing an opening in the roof consists in tilting a movable glass mounted on a frame towards the exterior of the vehicle around an axis attached to the plane of the roof, in order to release a passage between the window glass and the frame.

This technique has the disadvantage of allowing for only a half-opening of the window glass in order to prevent it from being pulled off under the effect of the aerodynamic pressure and to be generally implemented only for window glasses of small size.

Another sunroof technique also used conventionally consists in reducing the glass movable above or below the roof in a plane that is substantially parallel to the plane of the roof. A first technique for a roof pierced with a window that can be closed off by a sliding glazed panel housed in the lining of the roof is thus known. A disadvantage of this technique is that the dimensions of the openings in the roof, and consecutively of the glazed surfaces making it possible to close them off, are limited.

In the case where this approach is implemented for glazed surfaces covering the width of a roof, it has been proposed to slide the lateral edges of the window glass in guide rails arranged along the spars of the roof.

It has also been proposed, in order to increase the opening surface in the roof, to slide the movable glass at least partially along the back window or to have the movable glass penetrate or exit from a specific housing located, for example, in the lining of the roof.

This technique has however many disadvantages.

As such, this technique for guiding lateral edges of the window glass in rails requires that the lateral edges of the glazed panel be parallel, or in other words a rectilinear guiding, in order to prevent unsightly apertures which could appear between the lateral edges of the window glass and the roof. This results in many adaptations in order to attach the sliding window glass to the body while following the longitudinal profile, generally curved, of the roof. Additional covers can in particular be apposed in order to conceal the means for guiding, actuating and driving the glass pane, which reduces the glazed surface of the roof.

Moreover, the means for guiding, actuating and driving the movable glass pane are heavy, bulky and complex to assemble. It is therefore necessary to provide a housing volume consequently, which reduces the volume available inside the vehicle, if the movable glass slides inside the vehicle. In addition, they have a high cost of manufacture and traditionally create sealing problems. Their assembly on the vehicle and maintenance are also complex. They furthermore have constraints in terms of ergonomics.

An even more critical disadvantage with this known technique is that a balancing of the forces exerted on the lateral edges of the panel sliding horizontally in order to displace this pane must be provided, in order to prevent it from becoming askew during its displacement and becoming blocked in the rails, which renders it complex.

On the other hand, from an aesthetic standpoint, this technique does not make it possible to obtain, seen from the exterior, a smooth appearance, flush with the body, due to the offset of the movable glass in relation to the plane of the roof, accentuated by the presence of a structure for guiding this window glass with rails.

### SUMMARY

An aspect of the present disclosure relates to a device for closing off a window arranged in a motor vehicle, comprising a fixed part intended to be attached to said vehicle and at least one movable glazed panel, able to be displaced according to a substantially horizontal sliding axis between a closed position, wherein it closes off an opening defined in said fixed part and at least one open position, wherein said opening is at least partially released.

According to an embodiment of the invention, such a device for closing off comprises at least one cable attached to said movable panel, one portion of said cable carrying said movable panel and being displaced in parallel to said sliding axis in order to displace said movable panel, and said cable engages with means for offsetting able to switch said movable panel from a closing plane, corresponding to the plane of said fixed part, to a sliding plane, parallel to said closing plane.

As such, in a simple and effective manner, this avoids the use of rails for carrying as well as guiding the movable glazed panel in its displacements according to the sliding axis and in the direction perpendicular to the closing plane. Moreover, the movable glazed panel can be displaced by acting directly on the cable.

According to a particular aspect of an embodiment of the invention, said sliding axis is substantially horizontal.

In an embodiment of the invention, such a device for closing off can in particular constitute a glazed roof of the vehicle

According to a preferred embodiment of the invention, said means for offsetting include at least an element forming a shuttle having at least one guide channel engaging with at least one finger protruding from said movable panel in order to provide said offset.

As such, it is easy to slide the panel in a direction of sliding or in an opposite direction.

According to a preferred approach, said channel has an inclined portion.

As such, the movable panel can be offset from the closing plane to the sliding plane in a tacking movement, which is aesthetic.

Advantageously, said inclined portion exits into a longitudinal locking portion.

As such the movable glazed panel can be locked in the closed position.

According to a preferred aspect, said cable substantially defines a loop, and said element forming a shuttle forms a complementary portion of said loop. As such the movable glazed panel can be displaced, via the element forming a shuttle, by pulling or pushing a strand of the cable.

Advantageously, a device for closing off such as described hereinabove comprises means for separating said cable in relation to said element forming a shuttle.

As such, the cable does not interfere with the element forming a shuttle.

In a particular embodiment of the invention, the means for separating can include a tensioner.

Advantageously, said cable is attached to a first and a second lateral edge of said movable panel.

As such, the movable panel is effectively supported from each side.

Advantageously, a device for closing off such as one of those described hereinabove comprises means of balancing and/or adjusting the tension of the cable on said edges of said movable panel.

As such, the movable panel is prevented from being displaced askew, which therefore makes it possible to guarantee that the opening can be closed off satisfactorily. On the other hand, the assembly and maintenance operations on the vehicle are simplified, by providing means for adjusting the tension of the cable.

According to a particular aspect of an embodiment of the invention, said cable substantially forming a loop, and two portions of said cable overlap by crossing.

As such, the displacement of the elements forming a shuttle is synchronised.

Preferably, said cable is stretched between at least four idle pulleys each mounted on an axis fixed to said vehicle, in such a way as to form a “U” around the trajectory of said movable panel.

As such, the cable is suitably stretched over its travel, and the window surface allowing light transmission is optimised.

According to an advantageous embodiment of the invention, such a device for closing off comprises means of driving said cable belonging to the group comprising at least:

pulley mounted on the shaft of a gear motor;

rollers actuated by a rack;

means of driving via friction.

Preferably, said cable engages with at least one shock absorber, and at least one portion of said cable is introduced into a fixed plastic sheath.

As such, the travel of the cable can be adjusted, and the movement of the cable can be fluidified, without generating additional noise.

An embodiment of the invention also relates to a motor vehicle provided with one of the devices for closing off such as described hereinabove.

### BRIEF DESCRIPTION OF THE DRAWINGS

Other characteristics and advantages shall appear more clearly when reading the following description of a particular embodiment of the invention, provided as a simple and non-restricted example, and the annexed drawings, wherein:

FIG. 1 shows an embodiment of a device for closing off according to an embodiment of the invention forming a roof of a vehicle;

FIG. 2 is a detailed perspective view of the movable glazed panel carried by a cable that is integral with the device shown in FIG. 1;

FIG. 3 shows the fastening of the cable with a shuttle of the device for closing off shown in FIG. 1;

FIGS. 4A to 4D show the successive steps of the movement of the shuttle shown in FIG. 3 and of a finger protruding from the movable panel in relation to a channel formed in the shuttle, during the releasing starting from the closed position (FIG. 4A: in closed position; FIG. 4B in an unlocked position; FIG. 4C: in a clearance position; FIG. 4D in an open position);

FIG. 5 is a detailed view of the stop feet of a sheath for maintaining the cable shown in reference to FIG. 3 making it possible to maintain this cable on the front cross member of the roof of the vehicle.

### DETAILED DESCRIPTION OF ILLUSTRATIVE EMBODIMENTS

1. Reminder of the principle of an embodiment of the invention

The device for closing off according to an embodiment of the invention is intended to equip a vehicle. It is intended to be added to a window carried out in the body of the vehicle. Such a window can in particular be carried out on the roof of the vehicle, on a lateral wall, etc.

The general principle of an embodiment of the invention is therefore based on the implementation of a taught cable in order to support, displace and guide a movable glazed panel closing or releasing an opening provided in the device for closing off.

In at least one embodiment of the invention, this new approach makes it possible to make flush the face turned outwards of the glazed panel with a chassis element of the body and/or with a fixed glazed panel of the device for closing off, seen from the exterior of the vehicle.

2. Example embodiment of the invention

In what follows, we shall consider a vehicle roof formed by a device for closing off according to an embodiment of the invention added to the body of the vehicle.

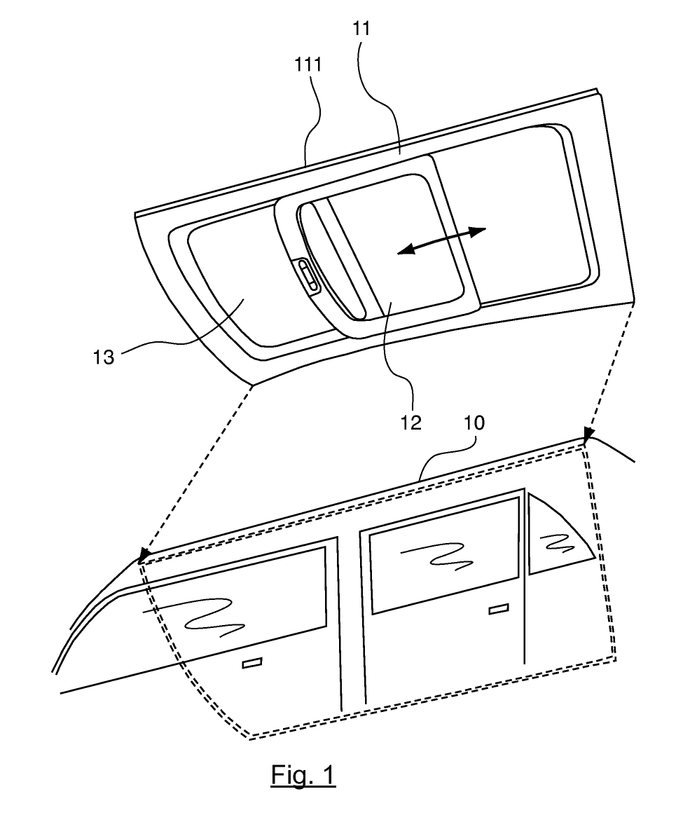

FIG. 1 shows in an underneath perspective view a particular embodiment of the invention for which the external contour 111 of the fixed part 11 of the device for closing off according to an embodiment of the invention is attached by bonding, as a flush fit, on an accommodating surround 10 of the chassis of the vehicle.

The fixed part 11 is made of tempered glass. It is advantageously curved in order to give the roof a shape responding to the current criteria in terms of design, comfort or penetration in the air, etc.

A movable glazed panel 12 made of thermoformed polycarbonate, shown in FIG. 1 in partial open position, makes it possible to close an opening 13 formed in the fixed part 11.

This movable panel 12 can slide, inside the vehicle, in relation to the fixed part 11 according to the substantially horizontal sliding direction, coming to close off or release the opening 13. During the closing of the opening, the movable panel is displaced successively in relation to the fixed part:
in the sliding plane, parallel to the plane formed by the fixed part, starting from the position shown in FIG. 1, where the opening is partially released, to a clearance position wherein the movable panel is located substantially across from the opening and is offset in relation to the fixed part; and
following a tacking movement according to a rising curve in order to allow for the switching of the movable panel from the clearance position to a closed position, wherein the movable panel is located in the same plane as the fixed part, still referred to as closing plane, and closes off the opening.

As can be seen more clearly in FIG. 2 in a detailed view of FIG. 1, for which the fixed part of the device shown in FIG. 1 has not been shown on purpose, the movable panel 12 is supported on its lateral edges 22₁, 22₂ by a polytoron cable 22 arranged in a “U” around the trajectory of the movable panel 12, of which the portions 23, 24 are taught between the front 25 and rear 26 cross members of the roof of the vehicle.

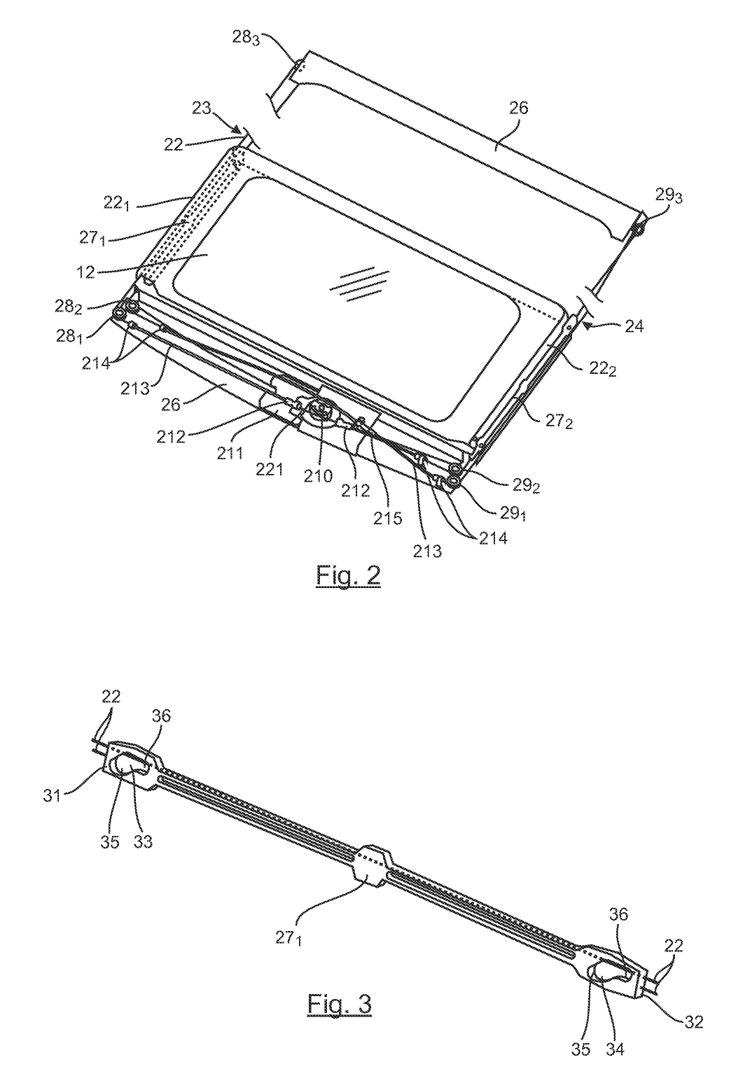

This cable 22 substantially forms a loop completed by two elements forming a shuttle 27₁ and 27₂, to which it is fixed. The fastening of the cable 22 by hooks 31, 32 provided at the ends of the element forming a shuttle 27₁ is specified in FIG. 3.

The lateral edges 22₁, 22₂ are, in this embodiment of the invention, attached to the cable 22 by the intermediary of elements forming a shuttle 27₁ and 27₂.

The cable 22 is stretched between the cross members 25 and 26 using two triplets of idle pulleys, 28₁, 28₂, 28₃, 29₁, 29₂, 29₃ arranged symmetrically in relation to the longitudinal axis of the roof.

A strand 221 of the cable 22 is driven by friction on a pulley 210 mounted on the axis of a gear motor 211 fixed on the front cross member 25 and can as such slide towards one end or the other of this cross member 25. A photovoltaic cell (not shown) is fixed on the fixed part in the vicinity of the rear cross member 26 in order to make it possible to supply with energy in an autonomous manner the gear motor 211 controlling the displacement of the cable.

The gear motor 211 as such makes it possible to put into movement the movable panel by displacing the portions 23, 24 of the loop parallel to the sliding axis of this panel.

On each side of this pulley 210, the cable strand 221 is attached to shock absorbers 212 making it possible to fluidify the movement of the cable and to reduce noise.

At each end of the front cross member 25, the idle angle return pulley 28₁, respectively 29₂, of vertical axis perpendicular to the plane of the front cross member 25, makes it possible to vehicle the cable along the lateral contours of the accommodating surround 10 to the idle pulley 28₃, 29₃, mounted on the rear cross member 26 around an horizontal axis.

At the exit of the pulley 28₃, respectively 29₃, the cable is sent back in the opposite direction to the angle return pulley 28₂, respectively 29₁ mounted at an end of the front cross member, around a vertical axis. Note that these pulleys 28₂, 29₁ are arranged in a plane that is lower than that of the pulleys in such a way as to prevent the return portions of the cable 22 from interfering with the elements forming a shuttle 27₁ and 27₂.

The portion of the cable 22 connecting the pulley 29₁ to the pulley 28₂ crosses the strand 221 connecting the pulley 28₁ to the pulley 29₂, by overlapping it, in order to allow for a displacement of the loop portions 23, 24 in the same direction.

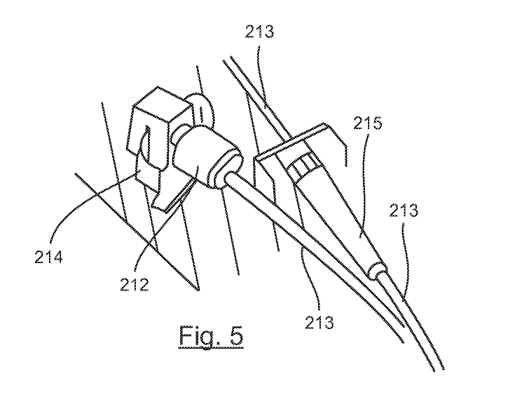

The cable 22 is maintained and guided on the front cross member 25 by a fixed semi-rigid sheath 213 wherein it is introduced, of which the ends are fixed to the cross member 25 via two stop feet 214, shown in a detailed view in FIG. 5.

Means for adjusting 215 the tension of the cable, allowing it to be constantly maintained taught, are arranged at the ends of the sheaths 213.

These means of adjusting (adjustment device) 215 moreover make it possible to provide a balancing of the tension of the cable in the portions 23, 24 and therefore to symmetrically displace the elements forming a shuttle 27₁ and 27₂ driving the movable glazed panel 12. As such, the movable panel 12 is prevented from adopting an askew position.

Each element forming a shuttle 27₁ or 27₂ has, as can be seen in FIG. 3, two guide channels 33, 34 each receiving a finger protruding transversally from the movable panel 22. Each channel 33, 34 has an inclined portion 35 making it possible to provide the offset of movable panel 12 from the closing plane to a sliding plane, parallel to the closing plane. In this particular embodiment of the invention, the height of each inclined portion is at least a few millimetres. In an alternative of this embodiment, it can be considered that the height of each inclined portion be substantially equal to eight centimetres.

These inclined portions 35 exit into a longitudinal locking portion 36 of the movable panel in the closed position.

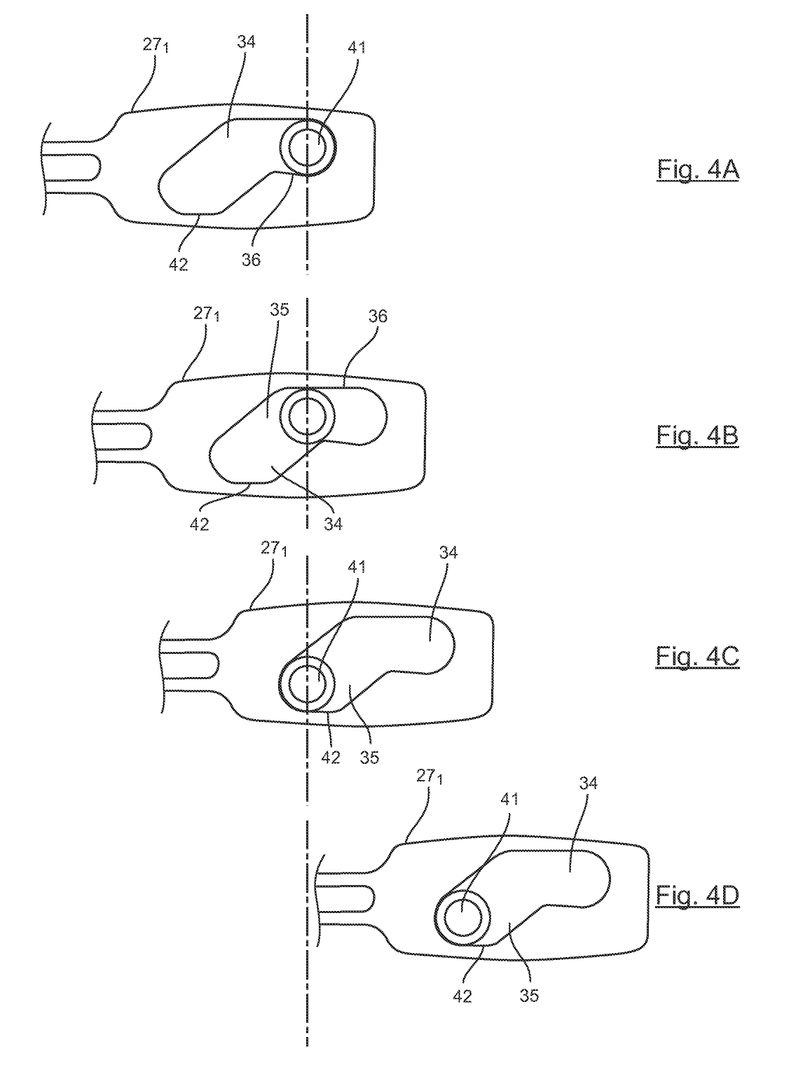

FIGS. 4A to 4D provide details on the movement of the element forming a shuttle 27₁ (or 27₂) and of the movable panel during the releasing starting from the closed position.

In FIG. 4A the movable glazed panel 12 is in closed position.

The finger 41 protruding from the movable panel 12 bears against the bottom of the locking portion 36.

When the gear motor drives the cable 22 and the element forming a shuttle towards the right, the locking portion 36 slides along the finger 41, until the finger 41 remaining fixed occupies an unlocked position, such as is shown in FIG. 4B.

Starting from the unlocked position, the movable glazed panel moves away from the opening, when the element forming a shuttle is again driven towards the right. It then tacks downwards, the finger 41 being guided in the inclined portion 35, to a clearance position, shown in FIG. 4C, below the closing plane. In this clearance position, the finger 41 is against the bottom of the inclined portion 35.

Starting from this clearance position, the displacement of the shuttle towards the right drives the sliding of the movable glazed panel 12 towards the right, parallel to the plane of the fixed part in an open position, such as illustrated for example in FIG. 4D, by progressively releasing the opening 13.

The opening 13 can then be closed off by inverting the direction of driving of the cable and the elements forming a shuttle, i.e. driving them towards the left, which makes it possible to progressively slide the movable glazed panel to the clearance position and to shift the movable glazed panel upwards to the closed position, as can be easily understood. In this movement of elements forming a shuttle towards the left, the channels 33 and 34 slide along each finger 41, initially maintained in contact with a lower longitudinal start-up surface 42 then guided upwards by the inclined portion 35, before penetrating into the locking portion 36.

3. Other characteristics and advantages of an embodiment of the invention

Other alternatives of the embodiment of the invention described hereinabove can be considered, among which:
the cable can be actuated by rollers actuated by a rack or means of driving via friction;
the cable can be separated from the elements forming a shuttle by a tensioner.

In an additional embodiment of the embodiment presented hereinabove, more than two channels can be provided in order to receive a corresponding number of fingers protruding from the movable glazed panel.

In yet another alternative of the invention, the device for closing off can be provided to close off a substantially vertical window of the vehicle, for example formed in a lateral wall of a vehicle. Note that in such an alternative, it can be useful to limit the dimensions and/or the mass of the movable glazed panel, in order to prevent the cable from sagging under the weight of the movable glazed panel.

An illustrative embodiment of the present disclosure provides a technique for closing off a horizontal window arranged in the body of a vehicle which is simple to implement.

At least one particular embodiment provides such a technique that allows for a maximized opening and which is as flush as possible with the body of the motor vehicle in such a way as to improve the aesthetic finishing of the body element whereon it is mounted while improving its aerodynamic performance.

In other words, at least one particular embodiment reduces or otherwise suppresses the presence, of at least the visual impression of a rupture that constitutes the offset movable window glass, in such a way that it is perceived as a transparent portion having no discontinuity with the body.

An embodiment provides such a technique, increasing the window surface allowing light transmission.

At least one particular embodiment provides such a technique that makes it possible to simplify the manufacture and the assembly of a roof on a roof window, and therefore to greatly reduce the corresponding costs.

At least one particular embodiment provides such a technique, making it possible to replace a fixed window glass mounted in a vehicle window by a device for closing off according to the present disclosure, without any particular adaptation on the window and more generally on the vehicle.

Although the present disclosure has been described with reference to one or more examples, workers skilled in the art will recognize that changes may be made in form and detail without departing from the scope of the disclosure and/or the appended claims.

1. A device for closing off a window arranged in a motor vehicle, comprising:
a fixed part adapted to be attached to said vehicle;
at least one movable glazed panel, able to be displaced according to a sliding axis between a closed position, wherein the panel closes off an opening defined in said fixed part, and at least one open position, wherein said opening is at least partially released;
at least one cable attached to said movable panel, a portion of said cable carrying said movable panel and being displaced parallel to said sliding axis in order to displace said movable panel; and
means for offsetting, which engages said cable and is able to switch said movable panel from a closing plane, corresponding to the plane of said fixed part, to a sliding plane, parallel to said closing plane.

2. The device for closing off according to claim 1, wherein said sliding axis is substantially horizontal.

3. The device for closing off according to claim 1, wherein said means for offsetting include at least one element forming a shuttle having at least one guide channel engaging with at least one finger protruding from said movable panel in order to provide said offset.

4. The device for closing off according to claim 3, wherein said channel has an inclined portion.

5. The device for closing off according to claim 4, wherein said inclined portion exits into a longitudinal locking portion.

6. The device for closing off according to claim 3, wherein said cable substantially defines a loop, and wherein said element forming a shuttle forms a complementary portion of said loop.

7. The device for closing off according to claim 6, wherein the device comprises means for separating said cable in relation to said element forming a shuttle.

8. The device for closing off according to claim 1, wherein said cable is attached to a first and a second lateral edge of said movable panel.

9. The device for closing off according to claim 8, wherein the device comprises means of at least balancing or adjusting tension of the cable on said edges of said movable panel.

10. The device for closing off according to claim 8, wherein said cable substantially forms a loop, and two portions of said cable overlap by crossing.

11. The device for closing off according to claim 10, wherein said cable is stretched between at least four idle pulleys each mounted on one axis fixed to said vehicle, in such a way as to form a “U” around the trajectory of said movable panel.

12. The device according to claim 1, wherein the device comprises means for driving said cable belonging to the group comprising at least:
pulley mounted on the shaft of a gear motor;
rollers actuated by a rack;
means of driving via friction.

13. The device for closing off according to claim 1, wherein said cable engages with at least one shock absorber, and at least one portion of said cable is introduced into a fixed plastic sheath.

14. A motor vehicle comprising at least one window arranged in its body and at least one device for closing off according to claim 1, fixed in a flush manner to said body in order to close off said window.
